(19) United States
(12) Patent Application Publication
(10) Pub. No.: US 2010/0004981 A1
(43) Pub. Date: Jan. 7, 2010

(54) Dynamic anti-money laundering system and methodology for providing situational-specific risk assessment determinations

(76) Inventors: Elazar Katz, Delray Beach, FL (US); Francis J. Liddy, Mt. Kisco, NY (US)

Correspondence Address: UNISYS CORPORATION, UNISYS WAY, MAIL STATION: E8-114, BLUE BELL, PA, 19424, US

(21) Appl. No.: 10/619,022

(22) Filed: Jul. 14, 2003

Related U.S. Application Data
(60) Provisional application No. 60/395,744, filed on Jul. 12, 2002.

(51) Int. Cl. G06Q 10/00; G06N 5/02; G06F 17/30; G06Q 40/00

(52) U.S. Cl. 705/11; 705/7; 705/30; 706/47; 707/104.1; 707/E17.044; 707/E17.032

(57) ABSTRACT

A dynamic anti-money laundering system and methodology for providing situational-specific risk assessment determinations. Risk dimensions for a financial institution or branch of a financial institution are identified and assigned numerical designations. The type of financial transaction to be conducted at the branch of a financial institution is then identified and it is further determined whether the financial transaction has a risk-related dimension and, if so, whether the numerical designation of at least a selected one of the identified risk dimensions exceeds a predetermined level. If the numerical designations of at least a selected one of the identified risk dimensions exceeds a predetermined level, a special risk assessment procedure is performed and recommended guidelines for handling the financial transaction based on the special risk assessment procedure ate provided to an authorized user.

### FIELD OF THE INVENTION

The present invention relates to the field of enterprise risk management. More specifically, the present invention provides an improved Anti-Money Laundering (AML) system and methodology for a financial institution that provides dynamic, contextually-driven compliance action analyses, guidance and recommendations, which may be based on predetermined risk dimensions of the financial institution or a particular branch of the financial institution, in order that situational-specific risk assessments may be made at the level of a particular site or branch of the financial institution.

### BACKGROUND OF THE INVENTION

Money laundering is a global concern that poses a significant threat to the world's financial institutions. This threat has blossomed in recent years in view of the advent of increased global electronic financial transactions. In the United States, regulators have taken an explicit approach to specifying the requirements of AML programs. Recent regulatory changes in the United States brought about by the USA Patriot Act of 2001, Public Law 157-56 to the “Currency and Foreign Transactions Reporting Act” (also known as the “Bank Secrecy Act” (BSA)), 31 U.S.C. §§ 1051 et seq., and ensuing regulations have significantly increased both the number of financial institutions that must implement Anti Money Laundering (AML) policies and the complexity of the requirements. The regulations require, inter alia, reporting of large cash transactions, retention of records, and the reporting of suspicious transactions and behaviors to the Financial Crimes Enforcement Network (FinCEN). Other regulators have taken less direct approaches, requiring banks to implement effective, risk-based programs, while leaving implementation details to the discretion of the institution. While it would seem that such a less-direct approach might be easier to implement, it is not necessarily so, since the institution is still required to implement solutions that are consistent with its level of exposure and risk, and the institution will have less guidance as to how to effectively realize such solution. In all cases, Failure to implement such policies in a satisfactory manner exposes the institute, as well as individual Compliance Officers to significant fines. Institutions also face risk to their respective reputations and goodwill should they be found lax in preventing money laundering and terrorism.

A globally important element of the regulations is that these AML policies require a “risk-based” approach to selecting appropriate measures. That is, organizations are required to identify and evaluate correctly the risk exposures associated with each area of operation and then apply counter measures that appropriately match the risk The rational used to choose these counter measures must be consistent, explainable, and defendable.

Anti Money Laundering (AML) solutions are an enterprise-wide undertaking involving multiple constituencies both within the organization and outside it. Internally, the initiative requires the coordinated effort of a large number of employees across multiple geographical locations. Externally, the effort is likely to involve ongoing communication with law-enforcement agencies as well as satisfying and giving comfort to regulatory agencies.

Training employees to perform their respective roles effectively in this area can be a significant challenge, considering that most financial institution employees have little or no background in law enforcement. Obtaining the approval of the various regulatory agencies also depends on the ability to articulate and communicate the rationale behind the AML program. For example, what risks have been identified? How was the severity of each of these risks at different geographical locations evaluated? Why is it believed that the measures taken are effective in addressing those risks?

The current generation of AML solutions focuses merely on the detection of transactions that look suspicious. These solutions usually employ various algorithms to try to identify which transactions should be flagged for further review. The problem with these AML solutions is that while they may adequately detect certain suspicious transactions, they do not take into account a significant number of important factors that can affect an appropriate evaluation of the risk exposures as associated with a particular area of operation, nor do the solutions assist in determining the appropriate counter measures that should be applied once it has been determined that there is a risk exposure. For example, some areas in which current AML solutions are lacking include:

1). Effective guidance once a suspicion is flagged. Current AML systems do not give assistance regarding what should be done with flagged suspicions. Since current systems generate a high volume of “false positives”, and there are risks in being either too lenient or too strict, institutions need a way to deliver advice to the point where it is needed.

2). Enterprise-based consistence. Because institutes are required by law to develop “risk based” policies, they need a means for implementing a consistent approach across the organization and for communicating their rational to regulators.

3). Access prevention. AML regulations cover more than just the monitoring of transactions. Due diligence procedures during account opening is another area where expertise is required. Again institutions must balance between the risk of failing to turn away criminals and the lost business involved in turning away a profitable customer.

4). Experience. Most employees of a financial organization have no experience in law enforcement. Training, monitoring, and coordinating problem escalation channels across the organization pose a major “change management” issue that is currently only partially addressed.

Accordingly, an improved AML methodology is needed that will take into account factors that can affect an appropriate evaluation of the risk exposures associated with a particular area of operation or transaction, and that can assist a financial institution's Compliance Officer or other authorized user in determining the appropriate counter measures that should be applied for a particular site or branch once it has been determined that there is a risk exposure.

### SUMMARY OF THE INVENTION

The present invention provides an improved Anti-Money Laundering (AML) system and methodology for a financial institution that provides dynamic, contextually-driven compliance action analyses, guidance and recommendations. The compliance action analyses, guidance and recommendations provided by the AML system and methodology of the present invention may be based on predetermined risk dimensions of the financial institution or a particular branch of the financial institution, and may be overridden by a Compliance Officer or other authorized user based on alternate analyses, guidance and recommendations provided by the AML system and methodology in view of the context or facts of the particular operation or transaction at the particular location.

According to one aspect of an embodiment of the present invention, risk dimensions are assigned to describe the risk profile of a particular site or branch of a financial institution. Additionally, handling procedure levels or categories are determined for each particular site or branch of a financial institution. Depending upon the nature and characteristics of the particular operation or transaction conducted by the financial institution, and the risk profile of a particular site or branch of a financial institution the category or level of the handling procedure that should be used for that particular operation or transaction at the particular institution or branch is based on one or more of the determined risk dimensions.

According to another aspect of an embodiment of the present invention, risk dimensions for a financial institution or branch of a financial institution are identified and assigned numerical designations. The type of financial transaction to be conducted at the branch of a financial institution is then identified and it is further determined whether the financial transaction has a risk-related dimension and, if so, whether the numerical designation of at least a selected one of the identified risk dimensions exceeds a predetermined level. If the numerical designations of at least a selected one of the identified risk dimensions exceeds a predetermined level, a special risk assessment procedure is performed and recommended guidelines for handling the financial transaction based on the special risk assessment procedure are provided to an authorized user.

According to yet another aspect of an embodiment of the present invention, there are at least four risk dimensions. A first risk dimension represents the risks due to the location of the branch of the financial institution and a second risk dimension represents the risks due to selected services offered by the branch of the financial institution. A third risk dimension represents the risks due to the nature of the customers served by the branch of the financial institution, and a fourth risk dimension represents the risks due to the jurisdictions served by the financial institution.

According to still another aspect of an embodiment of the present invention, the Anti-Money Laundering system includes a risk assessor module for providing to an authorized user of the anti-money-laundering system, guidelines in identifying risks associated with the branch of the financial institution, and a policy builder module for recommending possible electronic and manual countermeasures to the risks identified by the risk assessor module and for enabling the authorized user to select the countermeasures of his choice in order to create a policy for the branch of the financial institution. The system further includes an account opening due diligence module for providing detailed recommendations to the authorized user as to whether to allow an application for account at the branch of the financial institution and for applying consistent implementation of the policy throughout the branch of the financial institution, and a transaction activity monitor module for receiving and monitoring transaction information including transaction information received by the account opening due diligence module, and for identifying suspicious patterns among the transactions at the branch of the financial institution in order to provide a suspicious transaction activity report. A case management and reporting module tracks and identifies the detailed recommendations of the account opening due diligence module in order to provide continuous feedback to the authorized user about the effectiveness of the system

According to still another aspect of an embodiment of the present invention, the risk dimensions that are used in forming the compliance action analyses, guidance and recommendations are based on local laws, regulations, historical data, and other information that are specific to a particular site or branch of the financial institution.

According to another aspect of the present invention, the Anti-Money Laundering (AML) system and methodology of the present invention provides alternative compliance action analyses, guidance and recommendations which the Compliance Officer or other authorized user may use to override the initial compliance action analyses, guidance and recommendations, based on the on the context or facts of the particular operation or transaction presented to the Compliance Officer or other authorized user.

Other features of the present invention will become evident hereinafter.

### BRIEF DESCRIPTION OF THE FIGURES

The foregoing summary, as well as the following detailed description, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 shows a diagram of one embodiment of the dynamic AML system of the present invention.

FIG. 2 shows a preferred embodiment of the AML logic of the dynamic AML system of the present invention.

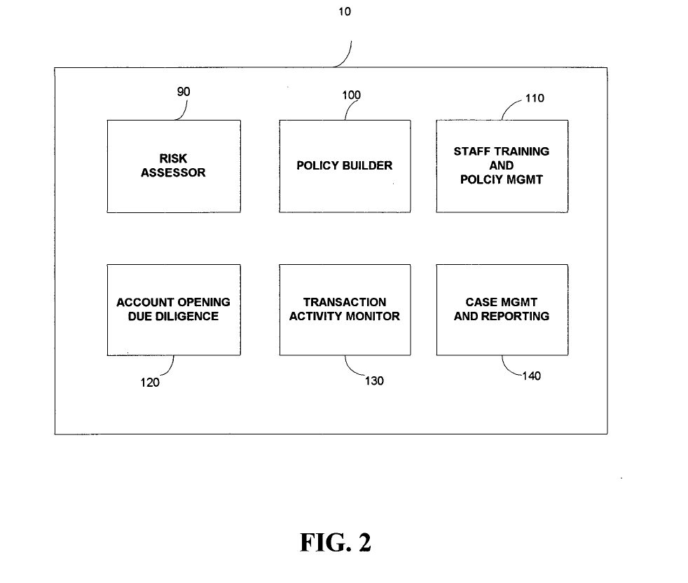

FIG. 3 is a flowchart showing the processing and identification of situational-specific risks by the Risk Assessor Module;

FIG. 4 is flowchart showing an embodiment of risk dimension determination in accordance with a preferred embodiment of the dynamic AML system of the present invention.

### DETAILED DESCRIPTION OF THE INVENTION

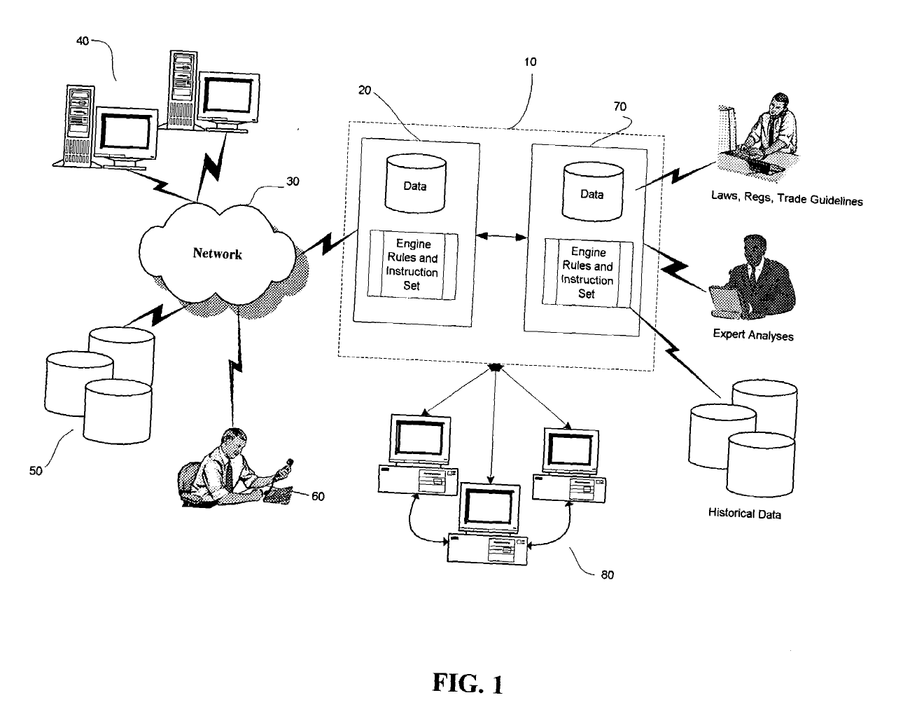

Referring to FIG. 1, the present invention provides an improved Anti-Money Laundering (AML) system 10 for a financial institution that provides dynamic, contextually-driven compliance action analyses, guidance and recommendations preferably based on predetermined risk dimensions of the financial institution or a particular branch of the financial institution. In a preferred embodiment of the AML system 10 of the present invention, a detection engine 20 receives risk-related information via accessing a network of information 30, including federal, state and local criminal systems 40, federal, state and local repositories 50, and other information, such as from human resources 60 (e.g., other branches of the same financial institution). The detection engine 20 communicates with the knowledge engine 70 of the AML system 10, the knowledge engine storing and applying previously garnered local laws, regulations, historical data, trade organization guidelines, expert analyses, and other information that is specific to a particular site or branch of the financial institution. The AML system 10 provides compliance action analyses, guidance and recommendations to the Compliance Officer or other authorized user(s) 80. Preferably, the AML system 10 of the present invention also preferably provides alternative compliance action analyses, guidance and recommendations which the Compliance Officer or other authorized user may use to override the initial compliance action analyses, guidance and recommendations, extend any grace period, or deny the customer application, in view of the context or facts of the particular operation or transaction at the particular location.

### I. AML System Logic

The AML system 10 may be embodied as any rule-based, Bayesian network, dynamic knowledge network, or other form of inference engines, and preferably, the AML system 10 of the present invention is communicatively coupled to an electronic network including a plurality of databases and other information sources, and collects and collates information from numerous various databases including, (i) government sources; (ii) international organizations; (iii) regulatory agencies; (iv) self regulating trade organizations; and (v) commercial database firms. In one embodiment, the AML system and methodology of the present invention runs on Jnana Logic System 3.0, which is commercially available from Jnana Technologies Corporation, 469 Seventh Avenue, 13^{th} Floor, New York, N.Y. 10018. However, it will be appreciated that the present invention is not so limited and may execute on any similar platform.

In a preferred embodiment of the present invention, the AML system 10 includes the following modules:

### A. Risk Assessor Module 90

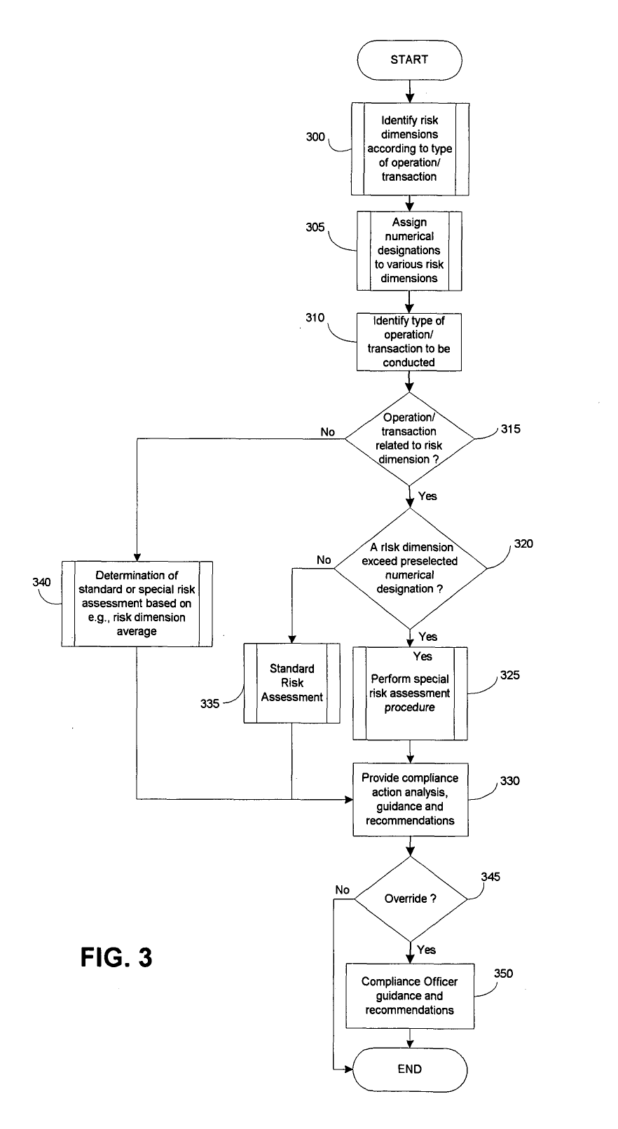

The Risk Assessor Module 90 guides the Compliance Officer or other authorized user in identifying the unique risks associated with each branch or business unit of the financial institution including, among others, geographic location, types of customers served, types of services offered, jurisdictions served by the financial institution. The operation of this module will be discussion in more detail later with reference to FIG. 3.

### B. Policy Builder Module 100

The Policy Builder Module 100 recommends possible electronic and manual counter measures to the risks identified and enables the Compliance Officer or other authorized user to select the measures of their choice. The system then creates a policy to fit the items selected. This module also functions in reverse order—describing the decision process that was involved in setting the policy. In this mode, the system is useful for defending the risk-based rationale behind the policy and any differences in policy between different business units.

### C. Staff Training & Policy Management Module 110

The Staff Training and Policy Management Module 110 is an optional module extends the organization's selection of measures to developing customized training programs and to tracking student compliance. Students answer a questionnaire regarding the branch in which they work, as well as their areas of responsibility or job description. From that information, the system can construct a recommended training program, deliver the material, and track progress.

### D. Account Opening Due Diligence Module 120

United States regulations are very specific about the due diligence required when opening new accounts. Other regulators are less specific, but nevertheless require prudent measures to eliminate potentially criminal persons. The Account 30 Opening Due Diligence Module 120 ensures consistent implementation of due diligence procedures throughout the organization. As with other modules, use of expert-system technology allows rich explanations regarding why certain applications have been denied or which crucial pieces of information have still not been provided. The system allows the authorized user to override any recommendations, to extend any grace period, or to deny the application.

### E. Transaction Activity Monitor Module 130

The Transaction Activity Monitor Module 130 monitors transaction and operation activities for suspicious patterns. Unlike other similar modules, which flag suspicious transactions but leave the bulk of the interpretation work to the Compliance Officer, or other authorized user, the Activity Monitor uses all available information—whether provided through activity scanning, during account opening due diligence, or through random comments by bank personnel—to assemble the most likely scenario and to explain the suspicion in real world terms. Rather then merely reporting that the account's activity has increased by 10% over last month's, the Transaction Activity Monitor identifies and reports, via a suspicious transaction activity report, behaviors in meaningful “real-world” terms such as:

“Customer seems to avoid personal contact”

“Customer attempts to mask large cash transactions”, and/or

“Customer's actions do not follow rational business sense”

The information used may include historical and other data that is detected, collected, and consolidated with known methods and/or sensing devices, e.g., pattern recognition, rule-based filters, or other forms of fact-gathering, sensing, or knowledge discovery techniques.

### F. Case Management and Reporting Module 140

It is important in any AML system that when issues are raised, they subsequently be dealt with and resolved in a timely manner. The Case Management and Reporting Module 140 of the AML system 10 of the present invention accomplishes this function by ensuring that items are not dropped until they are either resolved or dismissed. It also allows the authorized user to grant extensions and grace periods for gathering missing information or to cut short any further waiting. The case manager is also useful in providing continuous feedback regarding the effectiveness of the expert logic. By tracking and identifying those recommendations that are most often overridden, the Case Management and Reporting Module 140 can assist the authorized user in improving system logic to minimize false alerts. Similarly, the analysis can also detect employees that deviate from company policy by inappropriately overriding company procedures.

### II. AML System Operation

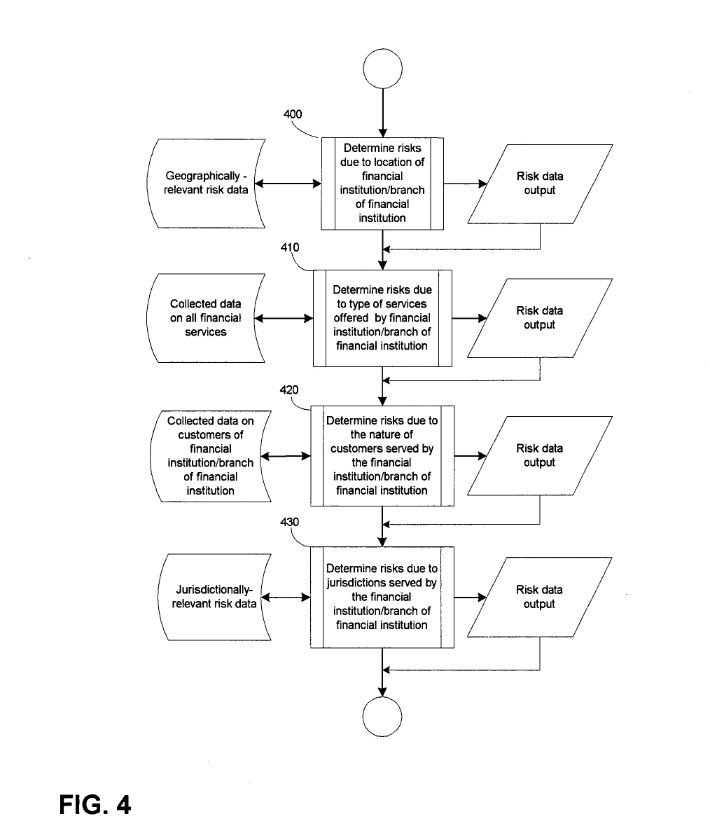

In operation, and with reference to FIG. 3, the Risk Assessor Module 90 of the AML system 10 of the present invention first identifies the risk dimensions according to the type of operation/transaction that are carried out in the branch of the financial institution (Step 300). The Risk Assessor Module 90 then assigns numerical designations to thus identified risk dimensions (Step 305). Further detail regarding risk dimensions will be had with reference to FIG. 4 in the subsequent paragraphs.

After the Risk Assessor Module 90 assigns numerical designations to the identified risk dimensions, the type of financial transaction/operation to be conducted is identified (Step 310). The Risk Assessor Module 90 then determines whether the financial transaction to be conducted has a risk-related dimension (Step 315). If the financial transaction/operation to be conducted does have a risk-related dimension, then the Risk Assessor Module 90 determines whether the numerical designation of at least a selected one of the risk dimensions identified in Step 300 exceeds a predetermined level (Step 320). If at least a selected one of the identified risk dimensions exceeds a predetermined level, the Risk Assessor Module 90 performs a special risk assessment procedure (Step 325) and provides the output this procedure to the Policy Builder Module 100 (not shown), which provides compliance action analysis, guidance and recommendations to the Compliance Officer or other authorized user as to the handling of the particular financial transaction to be conducted (Step 330).

If none of the identified risk dimensions exceeds a predetermined level, the Risk Assessor Module 90 performs a standard risk assessment procedure (Step 335) and provides the output this procedure to the Policy Builder Module 100 (not shown). The Policy Builder Module 100 will again provide compliance action analysis, guidance and recommendations to the Compliance Officer or other authorized user (Step 300); however, such analysis, guidance and recommendations will be based on a standard risk assessment, and thus likely different than those performed for a special risk assessment.

Similarly, if at Step 315 it is determined that the financial transaction to be conducted does not have any risk-related dimensions, the determination of whether to perform a standard or special risk assessment will be determined on some other basis; e.g., the average of risk dimensions for that particular transaction/operation (Step 340).

### III. Risk Dimensions/Procedural Levels

As discussed above, the AML system 10 of the present invention includes a 10 Risk Assessor Module 90 for guiding the Compliance Officer or other authorized user in identifying the unique risks associated with each branch or business unit of the financial institution. In one embodiment of the present invention, and with reference to FIG. 4, the risk dimensions determined by the Risk Assessor Module 90 include:
1). Risks due to location of the financial institution or branch of the financial institution (Step 400);
2). Risks due to the type of services the financial institution offers or branch of the financial institution (Step 410);
3). Risks due to the nature of the customers served by the financial institution or branch of the financial institution (Step 420); and,
4). Risks due to the jurisdictions served by the financial institution (Step 430)

The first and fourth risk dimensions may be arrived at by assigning a risk level to the various jurisdictions in which the branch or financial institution is or could be located. Both dimensions could be based on historical data regarding incidences occurring in the location and jurisdiction in general, or on incidences particular to the financial institution or branch of the financial institution itself. The other two risk dimensions may come from data collected regarding the various selected services offered by the branch or financial institution, as well as the profile of the customers appearing in the institution's client base.

The risk dimensions may be assigned a numerical designation (e.g., 1-10) or any other such scale. For example, at a financial institution or branch of the financial institution located in Cairo, Egypt, the following risks might be assigned:
Location risk—3
Customer base risk—4
Services offered risk—2
Jurisdictions served risk—3

For each of the above risk dimensions, the number of accounts associated with a given service type or belonging to a certain business type may also be tracked. The risk in each category is determined by a count of items that have both high risk and high exposure ratings (number of accounts).

As set forth above, in operation, performance of a special or standard assessment procedure is determined based on whether the financial transaction to be conducted has a risk-related dimension, and whether the numerical designation of at least a selected one of the risk dimensions exceeds a predetermined level. Referring again to FIG. 3, if at least a selected one of the identified risk dimensions exceeds a predetermined level, the Risk Assessor Module 90 performs a special risk assessment procedure (Step 325).

Thus, for example, a procedure for opening an account could be based on the financial institution's or branch's risk dimensions in the “customer base” area, and could be designated “special” if the branch is deemed to be serving a high-risk clientele, or “standard,” if the customer base is deemed to be of average risk. A procedure for testing the financial institution's or branch's AML performance, on the other hand, may be unrelated to any specific risk dimension, and the decision whether to select a “standard” or “special” could be determined based on some other scale, such as the average score in all four risk dimension categories. The objective is to thus to establish logic that determines which level of each procedure should be used at the institution or branch, based on one or more of the risk dimensions defined above.

An operation or transaction that is designated “standard” may require an annual review, while that designated “special” may require a semi-annual review or similar designations, depending on the level of review that is deemed to be required. It will be understood to those skilled in the art, that these are merely exemplary, and that other distinctions may be made between a “standard” procedure and “special” procedure.

### IV. Procedure Override

Referring again to FIG. 3, the AML system 10 preferably allows the Compliance Officer or other authorized user to override compliance action analysis, guidance and recommendations provided by the Policy Builder Module 100 (Step 345). Such might be the case, if the Compliance Officer or other authorized user deems that the context or facts of the particular operation or transaction at the particular location warrant different action that that recommended by the Policy Builder Module 100. In such a case, the Compliance Officer or other authorized user will provide alternate analyses, guidance and recommendations (Step 350). In the case where the transaction involves the opening of an account, the Case Management and Reporting Module 140 then tracks and identifies those recommendations that are most often overridden and updates the Account Opening Due Diligence Module based on the override.

Thus, the improved AML system 10 of the present invention provides for the development of risk-based procedures that are site-or location-specific, and further allows for assistance in the articulation as to how these procedures were selected. The AML system 10 will provide for the (i) development, explanation, and defense of risk-based policies and procedures; (ii) development, explanation, and defense of risk-based training programs; (iii) determination of which new clients/customers to accept and which to reject; (iv) determination of which existing clients should be maintained and which should be rejected; and/or (vi) monitoring of ongoing business transactions for money laundering and/or other criminal and/or regulatory infractions. The improved AML system 10 of the present invention will also explain why certain transactions have been flagged as suspicious, provide the context behind selected transactions and simplifying further analysis of decision making, rank and prioritize flagged events and explain why some exceptions are considered more suspicious than others, explain the underlying rationale behind thresholds and limits, identify trends and typologies, and, leverage computer scanning and human interpretation to improve analysis.

While the invention has been particularly shown and described with reference to various embodiments thereof, it will be understood by those skilled in the art that various changes in form and details may be made therein without departing from the spirit and scope of the invention. Additionally, the present invention is by no means limited to use in the operating system environments discussed above, but rather, can be implemented in connection with any operating system.

1. An anti-money laundering system operating on a computing system containing encoded data that when executed provides risk assessment determinations at a branch of a financial institution, the anti-money laundering system comprising:
a risk assessor module operating on the computing system and configured to provide to an authorized user of the anti-money laundering system, guidelines in identifying risk dimensions associated with potential money laundering transactions processed by the branch of the financial institution;
a policy builder module operating on the computing system and configured to recommend possible electronic and manual countermeasures to the risks identified by the risk assessor module and to enable the authorized user to select the countermeasures of his choice in order to create a policy for the branch of the financial institution;
an account opening due diligence module operating on the computing system and configured to provide detailed recommendations to the authorized user as to whether to allow an application for an account at the branch of the financial institution and to apply consistent implementation of the policy throughout the branch of the financial institution;
a transaction activity monitor module operating on the computing system and configured to receive and monitor transaction information stored on a plurality of databases communicatively connected to the computing system, the transaction information including transaction information received by the account opening due diligence module, the transaction activity monitor module further configured to identify risk dimensions associated with potential money laundering transactions processed by the branch of the financial institution, assign numerical designations for the risk dimensions identified for the branch of a financial institution, and identify suspicious patterns among the transactions at the branch of a financial institution in order to provide a suspicious transaction activity report relating to a potential money laundering transaction that includes a scenario explaining the potential money laundering transaction based on the suspicious patterns; and,
a case management and reporting module operating on the computing system and configured to track and identify the detailed recommendations of the account opening due diligence module in order to provide continuous feedback to the authorized user about the effectiveness of the system;
wherein identifying suspicious patterns among the transactions includes determining whether a financial transaction to be conducted has a risk-related dimension;
determining whether the numerical designation of at least a selected one of the identified risk dimensions for the financial transaction to be conducted exceeds a predetermined level when the financial transaction to be conducted does have a risk-related dimension; and
performing a special risk assessment procedure if the numerical designation of at least a selected one of the identified risk dimensions exceeds a predetermined level.

2. The anti-money laundering system of claim 1, further comprising:
a staff training and policy management module configured to use the selected countermeasures to develop customized training programs and to track compliance of users of the anti-money laundering system.

3. The anti-money laundering system of claim 1, wherein the risks identified by the risk assessor module comprise geographic location risk, types of customers served, and types of services offered by the financial institution.

4. The anti-money laundering system of claim 1, wherein the policy builder module provides detailed support for the decision process in creating the policy.

5. The anti-money laundering system of claim 1, wherein the authorized user may override for the branch of the financial institution, the detailed recommendations provided by the account opening due diligence module.

6. The anti-money laundering system of claim 1, wherein the transaction information received and monitored by the transaction activity monitor further comprises historical data.

7. The anti-money laundering system of claim 6, wherein the transaction information received and monitored by the transaction activity monitor further comprises input from employees of the branch of the financial institution.

8. The anti-money laundering system of claim 5, wherein the case management and reporting module tracks and identifies the detailed recommendations of the account opening due diligence module that are overridden by the authorized user, and updates the account opening due diligence module based on the override.

9. The anti-money laundering system of claim 1, wherein the risks identified by the risk assessor module are used to determine the level of review applied against a selected operation or transaction.

10. The anti-money laundering system of claim 9, wherein the level of review is selected from the group consisting of standard review and special review.

11. The anti-money laundering system of claim 1, wherein the system is communicatively coupled to an electronic network including a plurality of databases, and wherein the transaction activity monitor component gathers information stored on the plurality of databases in order to monitor the suspicious transactions, and processes the information to output the risk assessment guidelines and an explanation of the risk assessment guidelines.

12. A computer implemented method having a computing system containing encoded data that when executed provides anti-money laundering risk assessment determinations at a branch of a financial institution, the method comprising the steps of:
identifying risk dimensions associated with potential money laundering transactions stored in at least one of a plurality of databases and processed by the branch of the financial institution;
assigning, via the computing system, numerical designations for the risk dimensions identified for the branch of a financial institution;
identifying a type of financial transaction to be conducted at the branch of a financial institution;
determining whether a financial transaction to be conducted has a risk-related dimension;
determining whether the numerical designation of at least a selected one of the identified risk dimensions for the financial transaction to be conducted exceeds a predetermined level when the financial transaction to be conducted does have a risk-related dimension;
performing a special risk assessment procedure if the numerical designation of at least a selected one of the identified risk dimensions exceeds a predetermined level; and,
providing to an authorized user, via the computing system, recommended guidelines for handling the financial transaction to be conducted, based on the special risk assessment procedure.

13. The method of claim 12, further comprising the step of:
performing a standard risk assessment procedure if the numerical designation of none of the identified risk dimensions exceeds a predetermined level.

14. The method of claim 12, wherein the risk dimensions comprises:
a first risk dimension representing a risk due to a location of the branch of the financial institution;
a second risk dimension representing a risk due to selected services offered by the branch of a financial institution;
a third risk dimension representing a risk due to an identified nature of the customers served by the branch of a financial institution; and,
a fourth risk dimension representing a risk due to a particular jurisdiction served by the branch of a financial institution.

15. The method of claim 14, wherein the risk dimensions are based on local laws, regulations, historical data, and other information that is specific to the branch of a financial institution.

16. The method of claim 14, wherein each of the selected services has associated accounts, each of the associated accounts having a risk rating and a risk exposure rating, and wherein each risk dimension is based on the risk rating and the risk exposure rating of all associated accounts of all of the selected services.

17. The method of claim 16, wherein the second and the third risk dimensions are based on data collected from the selected services.

18. The method of claim 14, further comprising the step of:
performing a standard risk assessment procedure if it is determined that the financial transaction to be conducted does not have a risk-related dimension, wherein the standard risk assessment is based on the average of the numerical designation for all of the risks.

19. The method of claim 14, wherein the type of the financial transaction to be conducted at the branch of a financial institution comprises opening an account, and wherein the risk dimension for the account opening is based on the risk due to the identified nature of the customers served by the branch of the financial institution.

20. The method of claim 19, wherein the identified nature of the customers served by the branch of the financial institution includes high-risk clientele, and wherein the special risk assessment procedure is performed for the account opening.

21. The method of claim 13, wherein when it is determined to perform a special risk assessment procedure for a financial transaction, the special risk assessment procedure is performed semi-annually, and wherein when it is determined to perform a standard risk assessment procedure for a financial transaction the standard risk assessment is performed annually.

22. The method of claim 12, further comprising the step of:
overriding by an authorized user the recommended guidelines for handling the financial transaction to be conducted.

23. The method of claim 22, wherein the authorized user provides alternative guidelines after the step of overriding the recommended guidelines for handling the financial transaction to be conducted.
